(19) United States
(12) Patent Application Publication
(10) Pub. No.: US 2025/0345952 A1
(43) Pub. Date: Nov. 13, 2025

(54) Ball Joint Differential for Robot

(71) Applicant: Timeback Incorporated, Brooklyn, NY (US)

(72) Inventor: Mason Massie, Brooklyn, NY (US)

(21) Appl. No.: 19/077,607

(22) Filed: Mar. 12, 2025

Related U.S. Application Data
(60) Provisional application No. 63/644,781, filed on May 9, 2024.

(51) Int. Cl. B25J 17/02; B25J 9/10; B25J 13/08; H02K 7/06

(52) U.S. Cl. CPC B25J 17/0258; B25J 13/088; H02K 7/06; B25J 9/104

(57) ABSTRACT

Rigid linkages are used implement a 2-DoF joint. The output link of the joint can revolve around a first axis and can rotate around a second axis that is orthogonal to and offset from the first axis. The output link is mounted on an intermediate link, which rotates around the first axis. The output link is connected by driving rods to a pair of input elements, which also rotate around the first axis. When the input elements rotate in the same direction around the first axis, the intermediate link and the output link revolve around the first axis in that same direction. When the input elements rotate in different directions or by different amounts around the first axis, the output link rotates around the second axis and also may revolve around the first axis.

### TECHNICAL FIELD

This application relates to robots and, more particularly, to mechanisms for jointed motion of robot limbs.

### BACKGROUND

Both humanoid and industrial robots are becoming ubiquitous. From puck-shaped vacuum cleaners to somersaulting combat droids, the technology has rapidly evolved. Many robots have jointed limbs with limited degrees of freedom (“DoF”). A joint in a robot limb may be driven by various mechanisms. One approach is to emulate animal skeletal movement with counteracting rigid linkages.

Presently, there exist a number of joint designs for humanoid and industrial robots, such as actuators, bevel gear differentials, intersecting axis cable differentials, or differentials where connecting rods run directly from the actuator output on the more proximal link directly to the distal link.

### SUMMARY

The technology disclosed by this application makes use of rigid linkages to implement a 2-DoF joint. The output link of the joint can revolve around a first axis and can rotate around a second axis that is orthogonal to and offset from the first axis. The output link is mounted on an intermediate link, which rotates around the first axis. The output link is connected by driving rods to a pair of input elements, which also rotate around the first axis. When the input elements rotate in the same direction around the first axis, the intermediate link and the output link revolve around the first axis in that same direction. When the input elements rotate in different directions or by different amounts around the first axis, the output link rotates around the second axis and also may revolve around the first axis.

### BRIEF DESCRIPTION OF THE DRAWINGS

FIG. 1A depicts an “exploded” view of an example of a two-degree-of-freedom (“2-DoF”) joint, which includes an intermediate link, an output link, two input elements, driving rods that connect the output link and input elements, and motors for driving the input elements, according to an aspect of the disclosure.

FIG. 1B depicts a fully assembled view of the 2-DoF joint that is shown in FIG. 1A, in a neutral position.

FIG. 2 depicts the 2-DoF joint that is shown in FIG. 1B, with the output link rotated to a −40 degree position on the second axis.

FIG. 3 depicts the 2-DoF joint that is shown in FIG. 1B, with the output link rotated to a +40 degree position on the second axis.

FIG. 4 depicts the 2-DoF joint that is shown in FIG. 1B, with the output link rotated to a −90 degree position on the first axis.

FIG. 5A depicts the 2-DoF joint that is shown in FIG. 1B, with the output link rotated to a +90 degree position on the first axis.

FIG. 5B depicts the 2-DoF joint that is shown in FIG. 1B, with the output link rotated to a +/−180 degree position on the first axis.

FIG. 6 depicts the 2-DoF joint that is shown in FIG. 1B, with the output link rotated to a −90 degree position on the first axis and to a −40 degree position on the second axis.

FIG. 7A depicts an “exploded” view of an example of a two-degree-of-freedom (“2-DoF”) joint, which includes an intermediate link, an output link, two input elements, driving rods that connect the output link and input elements, and motors and cranks for driving the input elements, according to an aspect of the disclosure.

FIG. 7B depicts a fully assembled view of the 2-DoF joint that is shown in FIG. 7A, with the output link in a neutral position.

FIG. 8A depicts an “exploded” view of an example of a two-degree-of-freedom (“2-DoF”) joint, which includes an intermediate link, an output link, two input elements, driving rods that connect the output link and input elements, and motors and belts for driving the input elements, according to an aspect of the disclosure.

FIG. 8B depicts a fully assembled view of the 2-DoF joint that is shown in FIG. 8A, with the output link in a neutral position.

FIG. 9A depicts an “exploded” view of an example of a two-degree-of-freedom (“2-DoF”) joint, which includes an intermediate link, an output link, two input elements, driving rods on opposite sides of the intermediate link that connect the output link and input elements, and motors for driving the input elements, according to an aspect of the disclosure.

FIG. 9B depicts a fully assembled view of the 2-DoF joint that is shown in FIG. 9A, with the output link in a neutral position.

FIG. 9C depicts a fully assembled view of the 2-DoF joint that is shown in FIG. 9A, with the output link in a neutral position.

FIG. 10A depicts an “exploded” view of an example of a two-degree-of-freedom (“2-DoF”) joint, which includes an intermediate link, an output link, two input elements, driving rods on opposite corners and opposite sides of the intermediate link that connect the output link and input elements, and motors for driving the input elements, according to an aspect of the disclosure.

FIG. 10B depicts a fully assembled view of the 2-DoF joint that is shown in FIG. 10A, with the output link in a neutral position.

FIG. 11A depicts an “exploded” view of an example of a two-degree-of-freedom (“2-DoF”) joint, which includes an intermediate link, an output link, an input element, an idler cam, a driving that connects the output link and input element, and motors for driving the input element and idler cam, according to an aspect of the disclosure.

### DETAILED DESCRIPTION

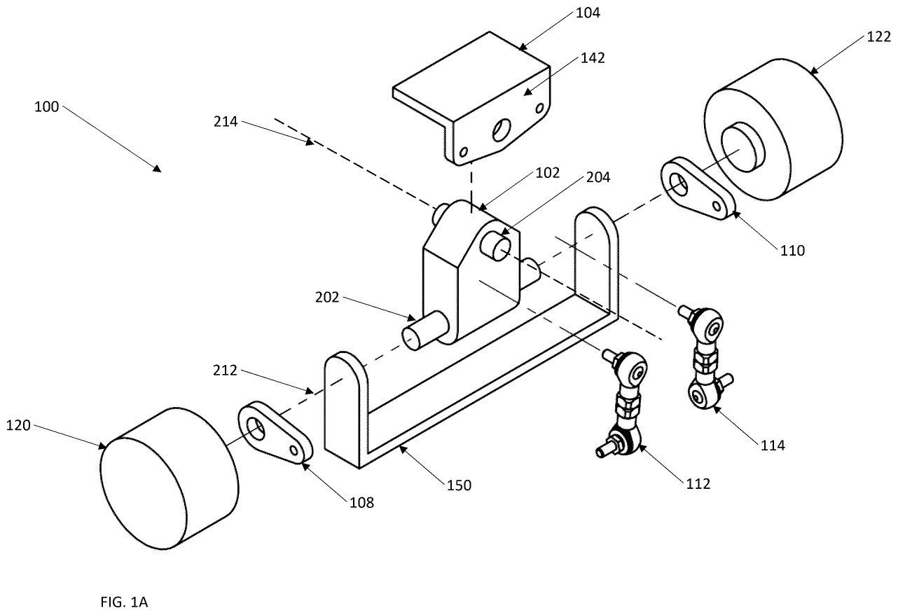

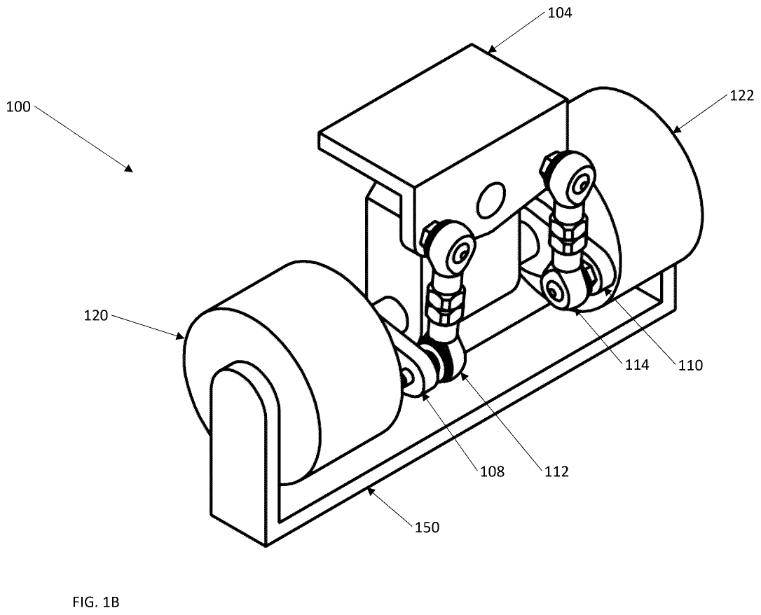

FIG. 1A depicts an “exploded” view of an example of a two-degree-of-freedom (“2-DoF”) joint 100. FIG. 1B depicts a fully assembled view of the 2-DoF joint 100. The joint 100 includes an intermediate link 102, output link 104, two input elements 108 and 110 (e.g., cams), driving rods 112 and 114 that connect the input elements 108 and 110 to the output link 104, and motors 120 and 122 for driving the input elements, according to an aspect of the disclosure. The input elements 108, 110 and the intermediate link 102 are independently rotatable around a first axis 212. The output link 104 is independent rotatable around a second axis 214. The second axis 214, which is defined by the intermediate link 102, can revolve around the first axis 212.

In FIG. 1B, the 2-DoF joint 100 is shown with the output link 104 in a neutral position. As further discussed herein, rotation of the input elements 108, 110 by the motors 120, 122 can move the output link 104 and intermediate link 102 to different positions with respect to the first and second axes 212, 214.

The driving rods 112, 114 are connected to a lobe of the input elements 108, 110, and to a leveraged point on the output link 104. The driving rods 112, 114 may have ball joints at either end allowing for increased articulation and configuring the driving rods 112, 114 as a two-force member, according to an aspect of the disclosure. According to other aspects of the disclosure, the driving rods 112, 114 may have a clevis joint or other joint allowing for similar function across a reduced range of motion and with less precision of movement.

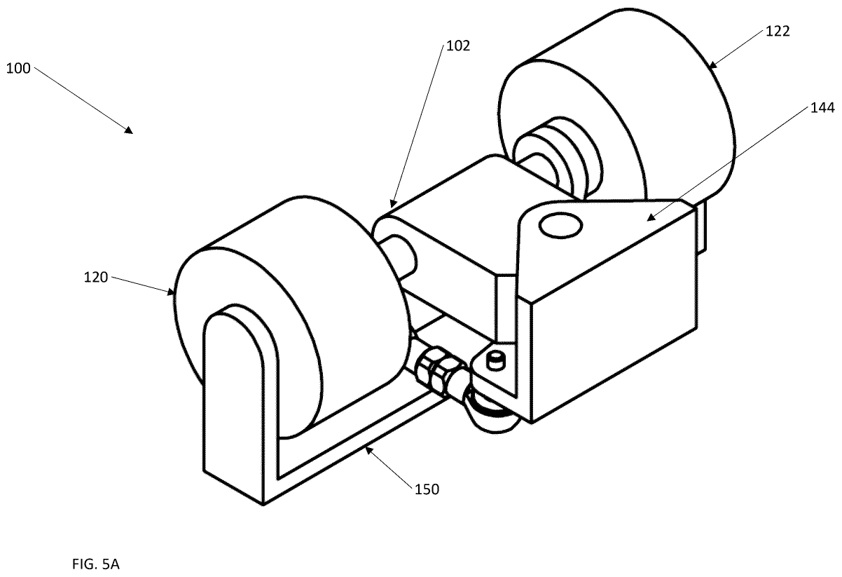

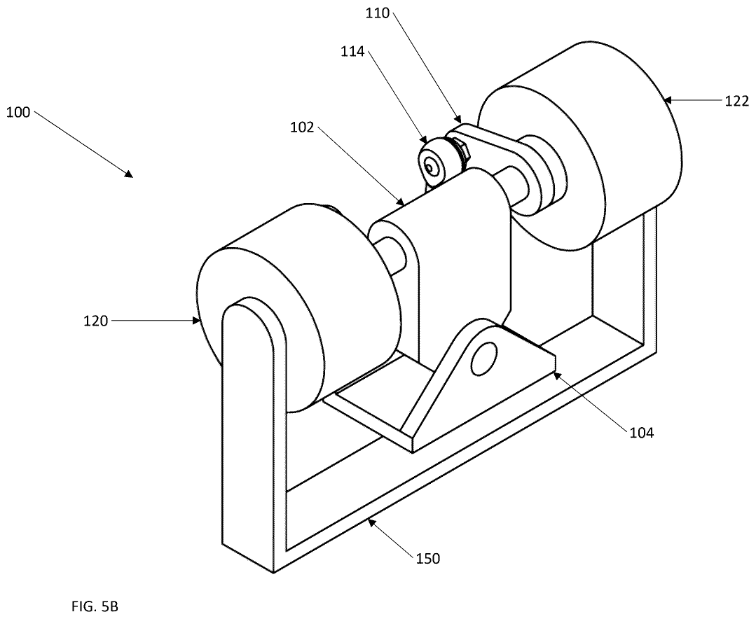

The intermediate link 102 includes a first axle 202 and also includes a second axle 204 that is disposed orthogonal to the first axle. When the 2-DoF joint 100 is fully assembled, the first axle 202 is rotatably connected between the input elements 108, 110 along the first axis 212 and the second axle 204 is rotatably connected between a first flange 142 and a second flange 144 (visible in, e.g., FIG. 5A) of the output link 104 along the second axis 214. The first and second axles are freely rotatable within the input elements and within the output link.

The axles 202, 204 are freely rotatable with respect to the input elements and output link. Therefore, motion of the intermediate link around the first axis, and motion of the output link around the second axis, are driven only by interactions of the driving rods with the input elements and output link. The output link 104 can move up to +/−40 degrees around the second axis 214, limited by physical interference of the driving rods 112, 114 with the intermediate link 102 and output link 104. A hard limit of +/−90 degrees rotation of the output link 104 about the second axis 214 is introduced when the angle between the input element 108, 110 and the respective driving rod 112, 114 approaches singularity. In some embodiments, the specific range of motion (“ROM”) of the ball joints on each end of the driving rods 112, 114 may introduce an independent hard limit which may be less than or greater than +/−40 degrees. The use of U-joints in place of ball joints on each end of the driving rods 112, 114 may offer more ROM than the ball joints, though other tradeoffs may exist and are known in the art (e.g., larger volume required for the discrete bearing elements and required pre-loading to reduce backlash). Physical interference of the driving rods 112, 114 with the intermediate link 102 and output link 104 may pragmatically limit designs in other embodiments to lesser ROM.

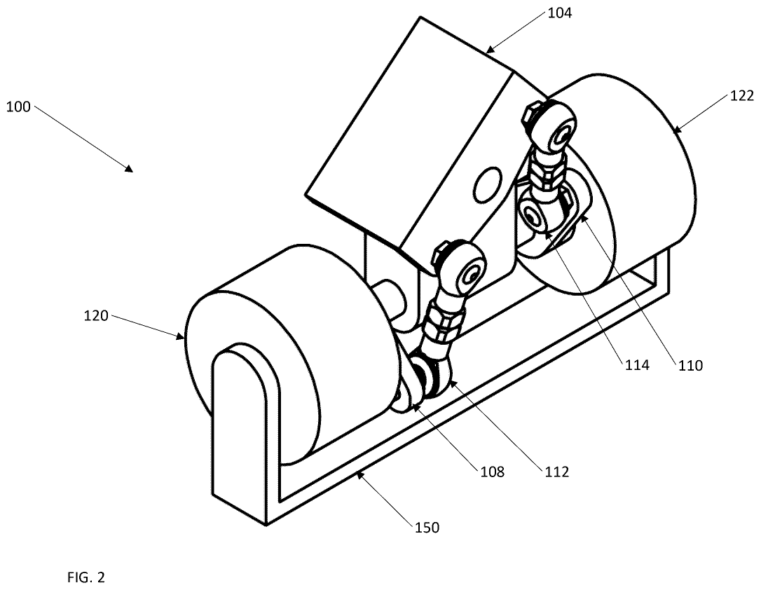

For example, rotating the top edge of the input element 108 toward the viewer and rotating the top edge of the input element 110 away from the viewer in FIG. 1B causes the output link 104 to rotate to a +40 degree position around the second axis, as depicted in FIG. 2.

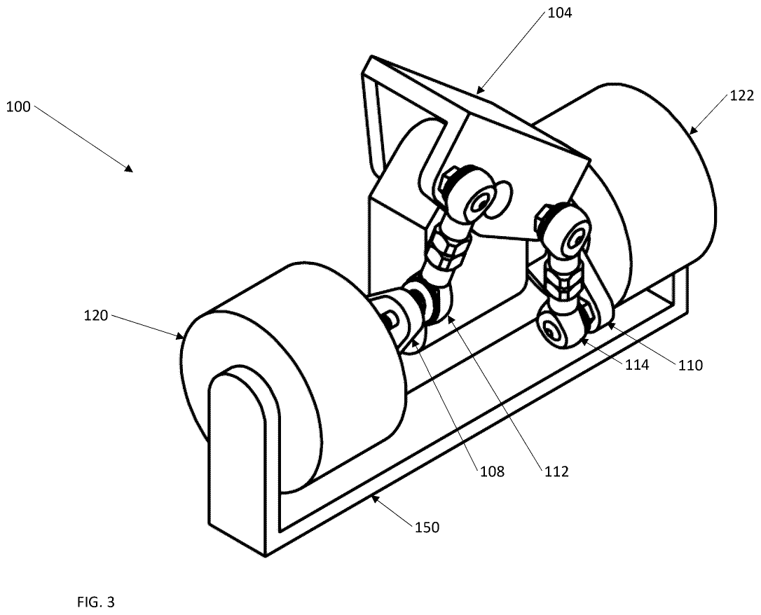

As another example of the kinematics of the 2-DoF joint 100, if the top edge of the nearer input element 108 is rotated away from the viewer in FIG. 2 while the top edge of the farther input element 110 is rotated toward the viewer, then the output link rotates to a −40 degree position around the second axis, as depicted in FIG. 3.

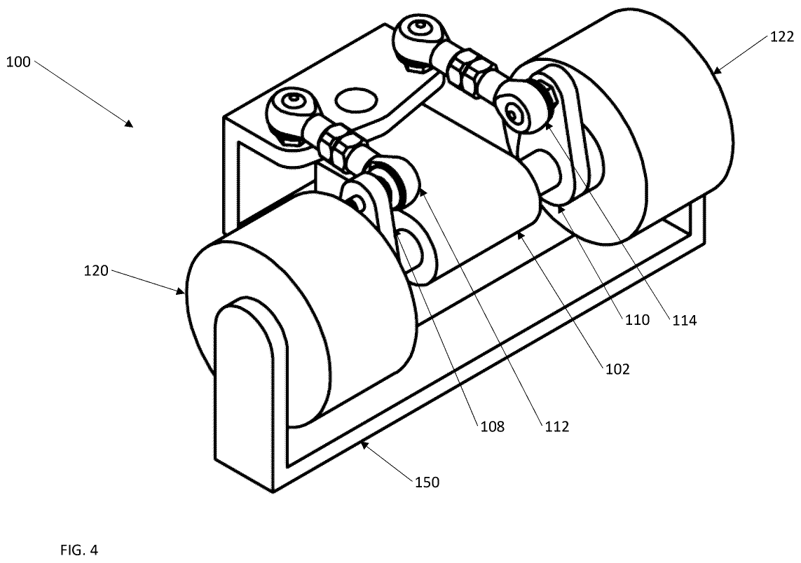

As another example of the kinematics of the 2-DoF joint 100, if the top edges of the nearer input element 108 and the farther input element 110 are rotated away from the viewer in FIG. 3, then the intermediate link 102 rotates and the output link revolves to a −90 degree position around the first axis, as depicted in FIG. 4.

As another example of the kinematics of the 2-DoF joint 100, if the top edges of the nearer input element 108 and of the farther input element 110 are rotated toward the viewer of FIG. 4, then the intermediate link 102 rotates and the output link 104 revolves to a +90 degree position around the first axis, as depicted in FIG. 5A.

As another example of the kinematics of the 2-DoF joint 100, if the top edges of the nearer input element 108 and of the farther input element 110 are rotated toward the viewer of FIG. 5A, and sufficient clearance is provided between the mounting structure 150 and the output link 104, then the intermediate link 102 rotates and the output link 104 revolves to a +180 degree position around the first axis. With sufficient clearance provided between the mounting structure 150 and the output link 104, unlimited ROM around the first axis is feasible as depicted in FIG. 5B.

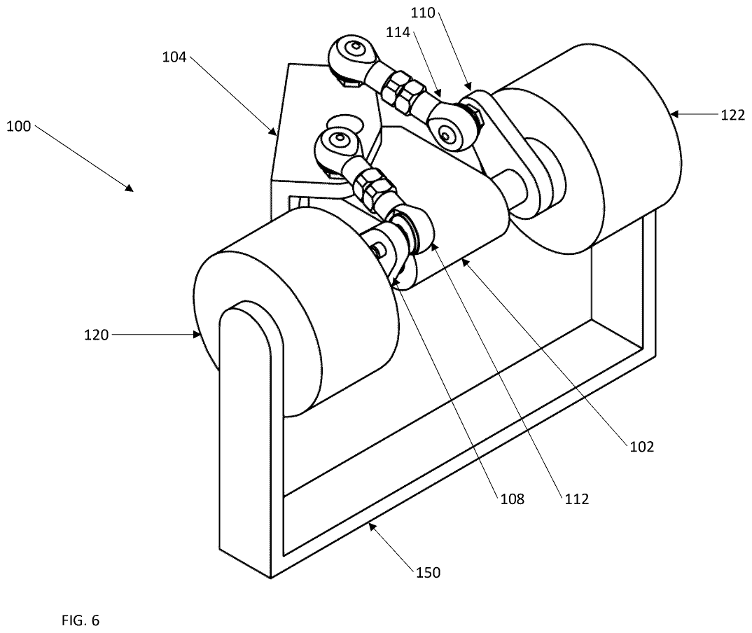

As another example of the kinematics of the 2-DoF joint 100, if the top edges of the nearer input element 108 and of the father input element 110 are rotated away from the viewer of FIG. 2 (where the output link 104 is already +40 degree position around the second axis), then the intermediate link 102 rotates and the output link 104 revolves to a −90 degree position around the first axis, as depicted in FIG. 6. Alternatively, such motion may also be accomplished by rotating the top edges of the nearer input element 108 and of the farther input element 110 away from the viewer in unequal amounts, with the farther input element 110 being rotated a larger number of degrees or at a faster rate than the nearer input element 108. In this example of the kinematics, the 2-DoF joint 100 is able to simultaneously articulate about both the first axis and the second axis. The 2-DoF joint 100 depicted in any of FIGS. 1A-10B may move in this type of combination or simultaneous motion.

As mentioned, the motors 120, 122 are connected to drive the input elements 108, 110. In some embodiments of the technology, the motors may be brushless DC permanent magnet motors that are controlled in closed loop mode by motor drivers in response to signals from optical, magnetic, hall effect, or capacitive/resistive/inductive position encoders. In other embodiments, the motors may be hydraulic motors that are controlled in closed loop mode by operation of solenoid valves in response to signals from Hall effect position encoders, or the motors may be other types of electric motors including induction motors, reluctance motors, stepper motors, or servo motors. In yet other embodiments, the motors may be controlled in closed loop or open loop by an autoencoder that outputs motor driver signals based on periodically processing weights of a computer vision neural network. This can be helpful in implementations where an “intelligent” robot is desired that can just be directed to pick things up from a general area and move the things to another general area, without specific direction. The skilled worker will be aware of many possible combinations of alternative motor configurations and control modes in light of the present disclosure.

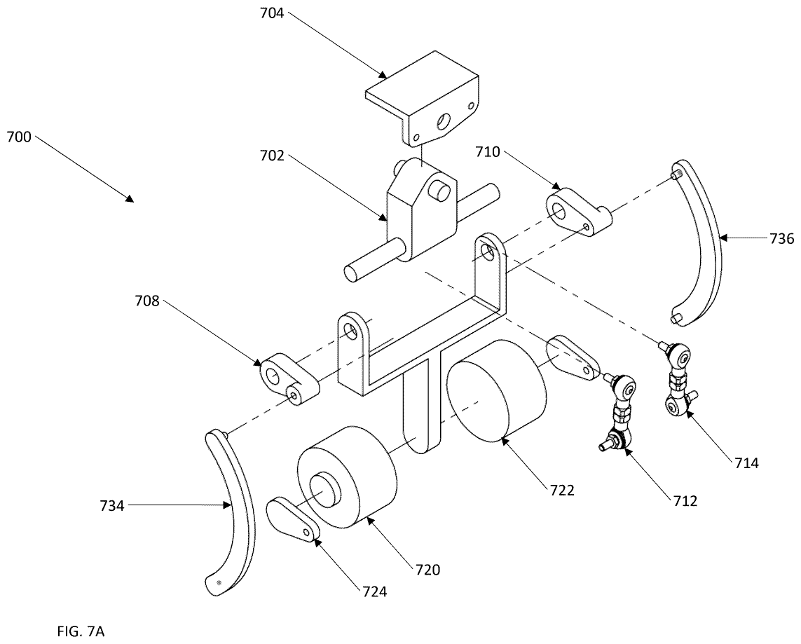

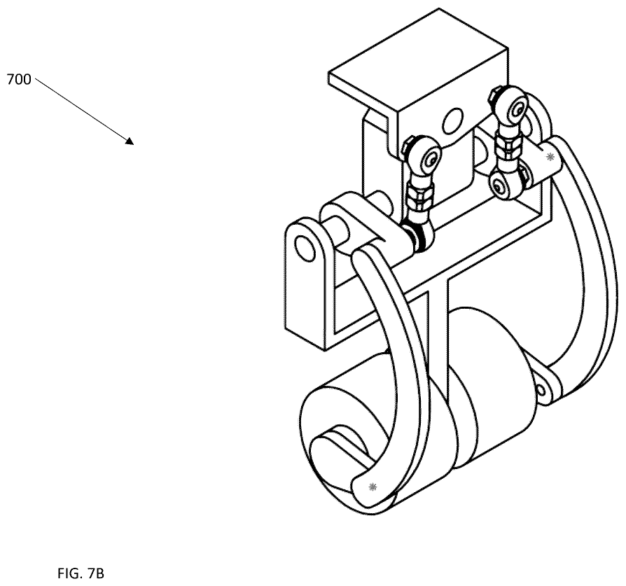

FIGS. 7A and 7B depict one variation of a ‘remoted’ motor embodiment. FIG. 7A depicts an “exploded” view of an example of a two-degree-of-freedom (“2-DoF”) joint 700, which includes an intermediate link 702, output link 704, two input elements 708 and 710, two crank cams 724 and 726, driving rods 712, 714 that connect the input elements and output link, and motors 720, 722 and cranks 734, 736 for driving the input elements, according to an aspect of the disclosure. FIG. 7B depicts a fully assembled view of FIG. 7A.

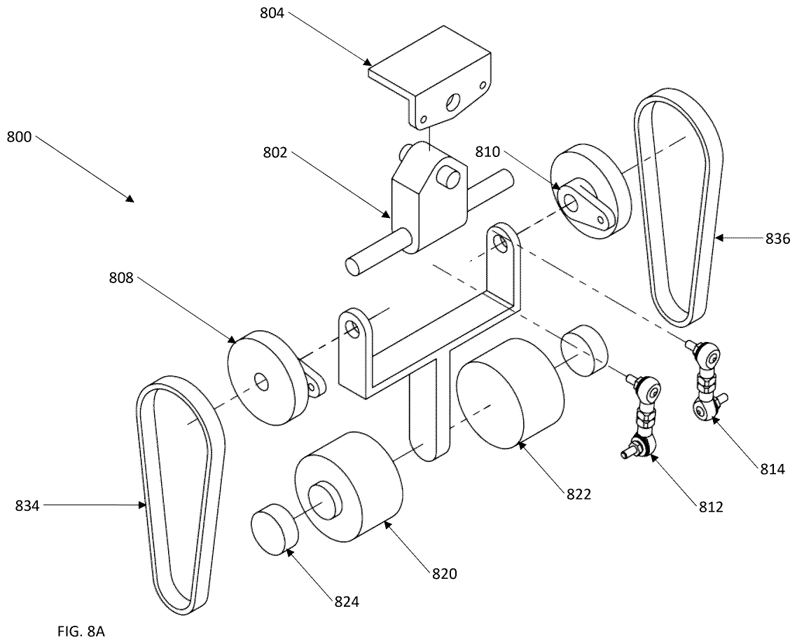

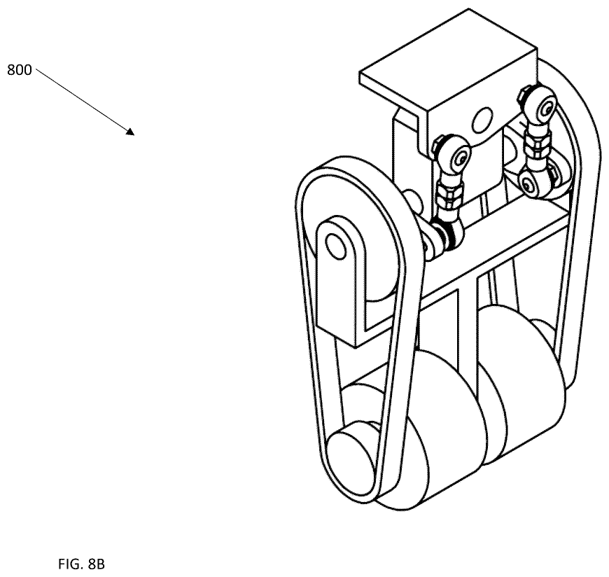

FIGS. 8A and 8B depict another variation of a ‘remoted’ motor embodiment. FIG. 8A depicts an “exploded” view of an example of a two-degree-of-freedom (“2-DoF”) joint 800, which includes an intermediate link 802, output link 804, two input elements 808 and 810, two belt pulleys 824 and 826, driving rods 812, 814 that connect the input elements and output link, and motors 820, 822 and belts 834, 836 for driving the input elements, according to an aspect of the disclosure. FIG. 8B depicts a fully assembled view of FIG. 8A.

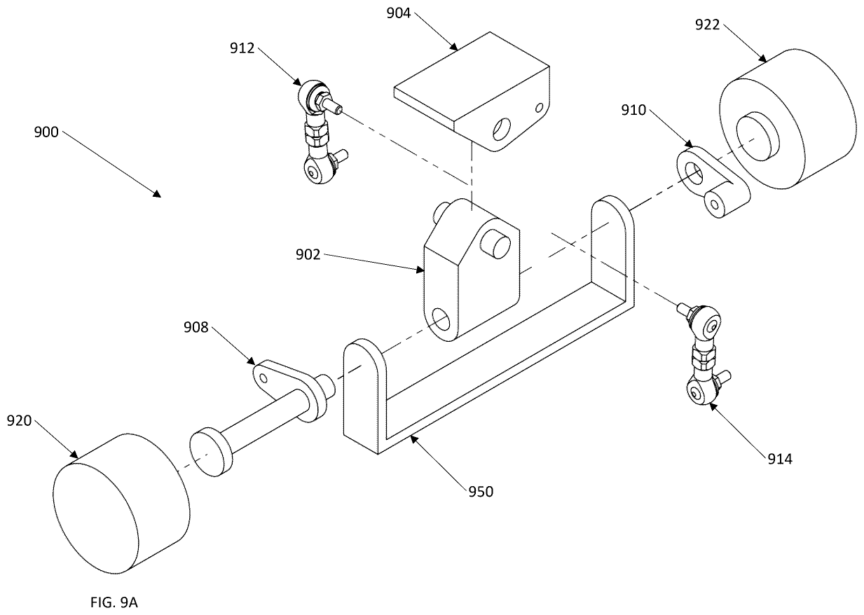

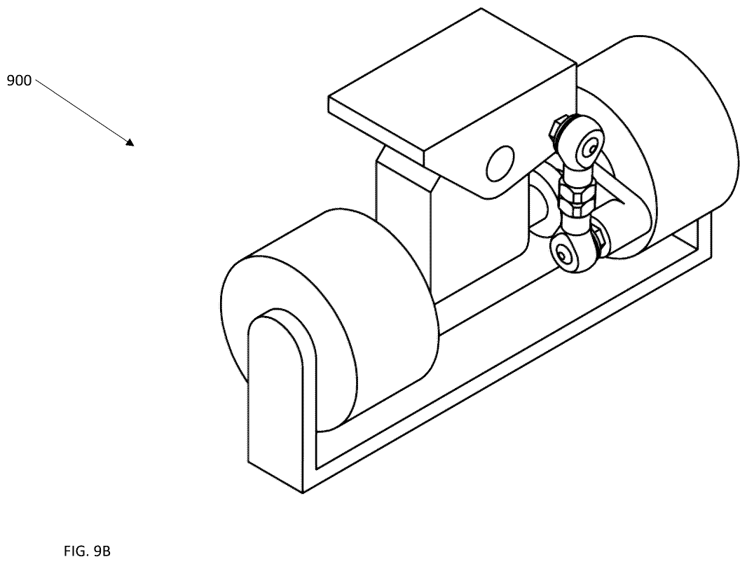

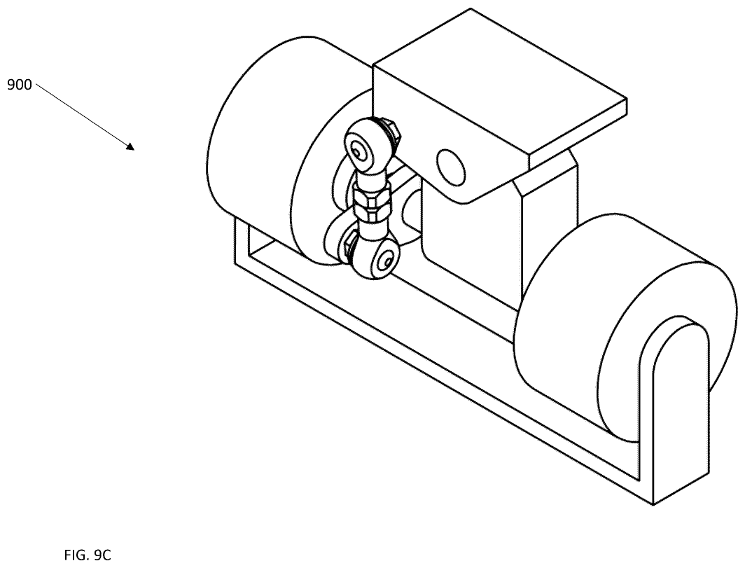

FIG. 9A depicts an “exploded” view of an example of a two-degree-of-freedom (“2-DoF”) joint 900, which includes an intermediate link 902, output link 904, two input elements 908 and 910, driving rods 912, 914 that connect the input elements and output link, and motors 920, 922 for driving the input elements, according to an aspect of the disclosure. FIG. 9B and FIG. 9C depict a fully assembled view of FIG. 9A.

The nearer input element 908 is located on the opposite side of the intermediate link 902 or on the same side of the intermediate link 902 as the farther input element 910. input elements 908, 910 are arranged on opposite sides of the first axis 212 (or axle 202), while the input elements are arranged on the same side of the second axis 214 (or axle 204). The distance between the nearer motor 920 and the intermediate link 902 is therefore smaller than the distance between the farther motor 922 and the intermediate link 902, particularly in comparison to the 2-DoF joints depicted in, e.g., FIGS. 1-8. The axle 202 is configured differently here than in the 2-DoF joints depicted in, e.g., FIGS. 1-8, and axle 202 is affixed to the motor 920 and input element 908 while passing through the intermediate link 902. input element 910 may freely rotate about the farther end of axle 202.

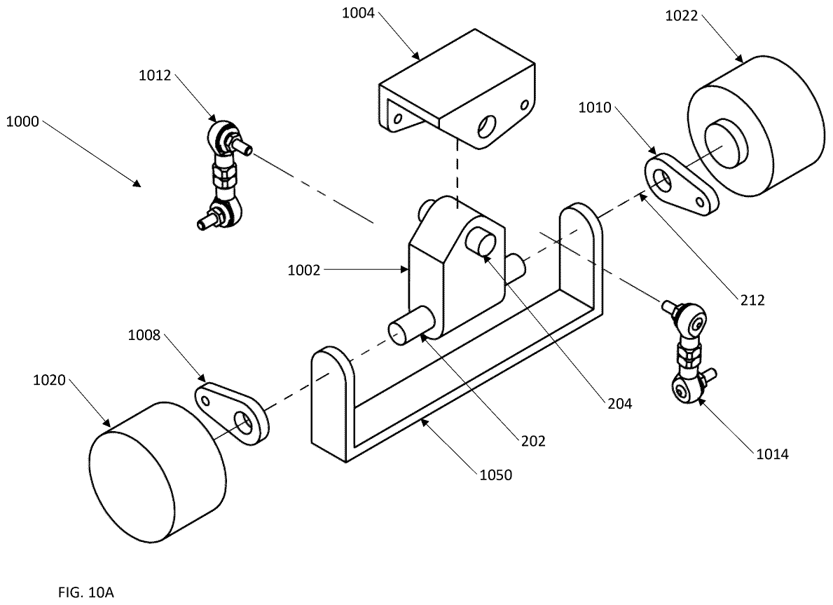

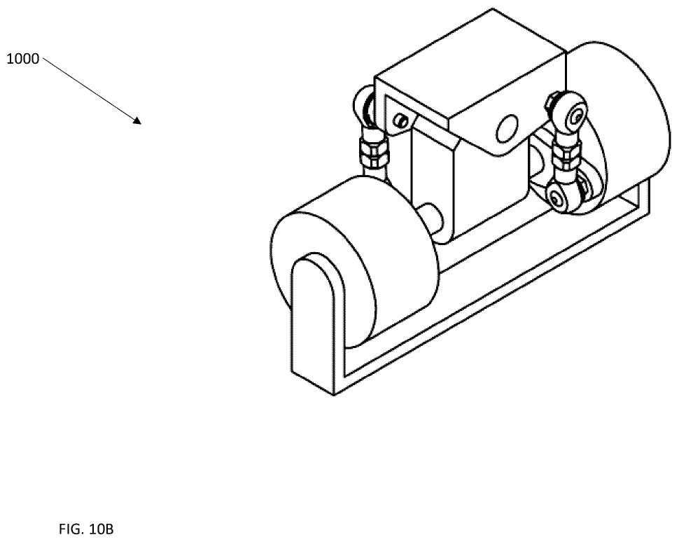

FIG. 10A depicts an “exploded” view of an example of a two-degree-of-freedom (“2-DoF”) joint 1000, which includes an intermediate link 1002, output link 1004, two input elements 1008, 1010, driving rods 1012, 1014 that connect the input elements and output link, and motors 1020, 1022 for driving the input elements, according to an aspect of the disclosure. FIG. 10B depicts a fully assembled view of FIG. 10A.

The nearer input element 1008 is located on the opposite sides of both the first axis 212 and the second axis 214 relative to the farther input element 1010.

What is claimed is:

1. A motor-drivable two degrees of freedom joint comprising:
a first input element that rotates around a first axis;
a second input element that rotates around the first axis, wherein the second input element is spaced apart from the first input element along the first axis, wherein the second input element can rotate independent from the first input element;
an intermediate link that is disposed between the first and second input elements along the first axis, wherein the intermediate link rotates around the first axis, wherein the intermediate link defines a second axis that is orthogonal to and offset from the first axis;
an output link that is mounted on the intermediate link and rotates around the second axis of the intermediate link;
a first driving rod, configured as a two force member, that is coupled between the first input element and the output link; and
a second driving rod, configured as a two force member, that is coupled between the second input element and the output link.

2. The joint of claim 1, wherein rotation of the input elements in the same amount around the first axis causes the intermediate link and output element to rotate only about the first axis, and rotation of the input elements in different amounts around the first axis causes the output element to rotate about at least the second axis.

3. The robotic limb assembly comprising at least one joint as claimed in claim 1, wherein said joint is operatively connected between a first limb segment and a second limb segment to provide relative rotational movement of the first and second limb segments in two degrees of freedom.

4. The joint of claim 1, wherein the first and second driving rods are coupled to the output link at opposite ends of a line through the second axis.

5. The joint of claim 2, wherein the first flange is closer to the first axis than is the second flange.

6. The joint of claim 1, wherein the first and second driving rods are disposed between the first and second input elements.

7. The joint of claim 1, wherein when the first link and the second link are aligned to each other, the output link is in a neutral position with respect to the second axis, and wherein the second axis is offset by a cranking distance from the first axis, the first and second two force members are coupled to the respective input elements at a driving distance from the first axis, and the first and second output two force members are coupled to the output link at a gimbal distance from the second axis, wherein the cranking distance is greater than the driving distance.

8. The joint of claim 7, wherein the gimbal distance is equal to the driving distance.

9. The joint of claim 1, further comprising a first motor connected to drive the first input element.

10. The joint of claim 9, wherein the second input element is selectively disconnected from the first input element.

11. The joint of claim 1, further comprising a first motor connected to drive the first input element and a second motor connected to drive the second input element.

12. The joint of claim 11, further comprising a motor controller processor that is configured by computer-executable instructions to implement a method comprising:
receiving a target sequence of rotary movements for the output link;
translating the target sequence of rotary movements to a sequence of motor commands for the first and second motors; and
rotating the output link around at least one of the first and second axes by driving the first and second motors according to the sequence of motor commands.

13. The joint of claim 11, wherein the first and second motors are brushless permanent magnet motors.

14. The joint of claim 11, further comprising first and second rotary encoders, which are associated with the respective first and second motors for closed-loop control of the motors.

15. The joint of claim 1, wherein the first and second input elements are selectably disconnectable from the output link to allow free rotation of the intermediate link around the first axis.

16. A method for moving a joint in two degrees of freedom, the method comprising, in any order:
rotating a first input element around a first axis while rotating a second input element around the first axis in the same direction and in the same amount as the first input element, thereby causing an output link to rotate around the first axis; and
rotating one of the first input element or the second input element around the first axis while rotating the other input element in the opposite direction in the same amount, thereby causing the output link to rotate around a second axis that is orthogonal to and offset from the first axis; and
rotating one of the first input element or the second input element around the first axis while;
rotating the other input element in the same direction in a different amount; or
rotating the other input element in the opposite direction in a different amount;
thereby causing the output link to rotate around both the second axis and the first axis.

17. The method of claim 16, further comprising starting with the first input element and the second input element aligned to each other.

18. The method of claim 16, further comprising rotating the first input element to an extreme position that is at least 360 degrees out of alignment from the second input element.

19. The method of claim 18, wherein when the first link and the second link are aligned to each other, the output link is in a neutral position with respect to the second axis, wherein at the extreme position of the first link, the output link is rotated +/−40 degrees from the neutral position around the second axis.

20. A non-transitory computer readable medium that is encoded with computer-executable instructions for implementing a target sequence of rotary movements around a first axis and around a second axis that is orthogonal and offset from the first axis, the instructions comprising instructions for:
receiving the target sequence of rotary movements;
translating the target sequence of rotary movements to a sequence of motor commands for first and second motors that respectively rotate first and second input elements of a two degree of freedom joint; and
driving the first and second motors according to the sequence of motor commands.
